(19) United States
(12) Patent Application Publication
(10) Pub. No.: US 2006/0288045 A1
(43) Pub. Date: Dec. 21, 2006

(54) Method for aggregate operations on streaming data

(75) Inventor: Gilad Raz, Mevaseret Tzion (IL)

Correspondence Address: DANIEL J SWIRSKY, 55 REUVEN ST., BEIT SHEMESH, 99544, IL

(73) Assignee: Digital Fuel Technologies, Inc.

(21) Appl. No.: 11/153,647

(22) Filed: Jun. 16, 2005

(51) Int. Cl. G06F 17/30

(52) U.S. Cl. 707/200

(57) ABSTRACT

A method for performing aggregate operations on streaming data, the method including executing an aggregation operation on data items in a set of data, maintaining the results of the aggregation operation in a temporary table together with metadata relating to the aggregation operation, maintaining the results of the aggregation operation in an output table, receiving a new data item not in the set of data, analyzing the metadata to determine if executing the aggregation operation on the data items in the set of data and the new data item would affect the results, and updating the output table as a function of the new data item.

### FIELD OF THE INVENTION

The present invention relates to streaming data processing in general, and more particularly to aggregate operations on streaming data.

### BACKGROUND OF THE INVENTION

In data processing a series of disjoint data items may be aggregated together to provide a fuller picture. For example, given a table in a relational database that includes multiple rows, where each row has two columns, a date column and an expense column, the total expenditure for a particular time may be calculated by aggregating the rows where the date field corresponds to the particular time and summing the expenses in those rows. To calculate the total expenditure for multiple periods of time, one might process the data with the following SQL statement:
SELECT date, SUM (expense) as “Total Expenditure”
FROM table
GROUP BY date;
   Each of the disjoint rows is aggregated with the SUM operator. Additionally, the SQL statement instructs the relational database to maintain multiple aggregations, one for each date. Thus, in the example shown in FIG. 1A, an input table 100a, is processed with the above SQL statement and generates an output table 110a.

When the data in the input table is modified, the output table may need to be adjusted. One well-known way to do this, shown in FIG. 1C, is to re-execute the aggregation query that previously generated the output table. Thus, continuing the example above, after table 110a is generated based on the data in table 100a, when the data in table 100a changes, such as by an addition of a row, as shown in FIG. 1B in table 100b, the SQL statement may be re-executed to produce the resultant table 110b.

While this methodology is simple, it unfortunately requires output table 110 to be fully reconstructed with each modification to the underlying data. This problem is particularly acute in a streaming data environment, where data continually arrives at a processor, such that processing of data may begin before the entire data set has arrived. Thus, in a streaming data environment, the output table would need to be continually reconstructed, which is a computationally expensive task.

### SUMMARY OF THE INVENTION

In one aspect of the present invention a method is provided for performing aggregate operations on streaming data, the method including executing an aggregation operation on data items in a set of data, maintaining the results of the aggregation operation in a temporary table together with metadata relating to the aggregation operation, maintaining the results of the aggregation operation in an output table, receiving a new data item not in the set of data, analyzing the metadata to determine if executing the aggregation operation on the data items in the set of data and the new data item would affect the results, and updating the output table as a function of the new data item.

In another aspect of the present invention the method further includes associating a timestamp with each of the data items, and identifying the new data item as having a timestamp that is later than the oldest timestamp of any of the data items reflected in the results.

In another aspect of the present invention the updating step includes inserting a new record into the output table to accommodate the results of the function.

In another aspect of the present invention the updating step includes modifying an existing record in the output table to accommodate the results of the function.

In another aspect of the present invention the updating step includes deleting an existing record in the output table to accommodate the results of the function.

In another aspect of the present invention the first maintaining step includes maintaining the number of rows of the data items reflected in the results.

In another aspect of the present invention the first maintaining step includes maintaining an indicator of an action that should be performed on the output table responsive to the new data item.

In another aspect of the present invention the method further includes indicating via the indicator any of insertion, deletion, modification, and no-action actions.

In another aspect of the present invention a method is provided for performing aggregate operations on streaming data, the method including executing an aggregation operation on data items in a set of data, maintaining the results of the aggregation operation in a temporary table together with metadata relating to the aggregation operation, maintaining the results of the aggregation operation in an output table, determining that one of the data items in the set of data has been modified, analyzing the metadata to determine if executing the aggregation operation on the data items in the set of data including the modified data item would affect the results, and updating the output table as a function of the modified data item.

In another aspect of the present invention the method further includes modifying the temporary table as a function of the modified data item.

In another aspect of the present invention the method further includes associating a unique identifier with each of the data items, maintaining a copy of the data items in the set of data in a current table together with their unique identifiers, identifying the modified data item as having a modification indicator, maintaining a copy of the modified data item in an update table together with its unique identifier, updating the temporary table as a function of the data item in the current table having the same unique identifier as the data item in the update table, and updating the temporary table as a function of the modified data item in the update table.

In another aspect of the present invention a system is provided for performing aggregate operations on streaming data, the system including means for executing an aggregation operation on data items in a set of data, means for maintaining the results of the aggregation operation in a temporary table together with metadata relating to the aggregation operation, means for maintaining the results of the aggregation operation in an output table, means for receiving a new data item not in the set of data, means for analyzing the metadata to determine if executing the aggregation operation on the data items in the set of data and the new data item would affect the results, and means for updating the output table as a function of the new data item.

In another aspect of the present invention the system further includes means for associating a timestamp with each of the data items, and means for identifying the new data item as having a timestamp that is later than the oldest timestamp of any of the data items reflected in the results.

In another aspect of the present invention the means for updating includes inserting a new record into the output table to accommodate the results of the function.

In another aspect of the present invention the means for updating includes modifying an existing record in the output table to accommodate the results of the function.

In another aspect of the present invention the means for updating includes deleting an existing record in the output table to accommodate the results of the function.

In another aspect of the present invention the first means for maintaining includes maintaining the number of rows of the data items reflected in the results.

In another aspect of the present invention the first means for maintaining includes maintaining an indicator of an action that should be performed on the output table responsive to the new data item.

In another aspect of the present invention the system further includes means for indicating via the indicator any of insertion, deletion, modification, and no-action actions.

In another aspect of the present invention a system is provided for performing aggregate operations on streaming data, the system including means for executing an aggregation operation on data items in a set of data, means for maintaining the results of the aggregation operation in a temporary table together with metadata relating to the aggregation operation, means for maintaining the results of the aggregation operation in an output table, means for determining that one of the data items in the set of data has been modified, means for analyzing the metadata to determine if executing the aggregation operation on the data items in the set of data including the modified data item would affect the results, and means for updating the output table as a function of the modified data item.

In another aspect of the present invention the system further includes means for modifying the temporary table as a function of the modified data item.

In another aspect of the present invention the system further includes means for associating a unique identifier with each of the data items, means for maintaining a copy of the data items in the set of data in a current table together with their unique identifiers, means for identifying the modified data item as having a modification indicator, means for maintaining a copy of the modified data item in an update table together with its unique identifier, means for updating the temporary table as a function of the data item in the current table having the same unique identifier as the data item in the update table, and means for updating the temporary table as a function of the modified data item in the update table.

### BRIEF DESCRIPTION OF THE DRAWINGS

The present invention will be understood and appreciated more fully from the following detailed description taken in conjunction with the appended drawings in which:

FIG. 1A is a simplified pictorial illustration of an exemplary set of tables, useful in understanding the present invention;

FIG. 1B is a simplified pictorial illustration of an exemplary set of modified tables, useful in understanding the present invention;

FIG. 1C is a simplified flowchart illustration of a method for performing aggregate operations, useful in understanding the present invention;

FIG. 2 is a simplified flowchart illustration of a method for performing aggregate operations, operative in accordance with a preferred embodiment of the present invention;

FIG. 3A is a simplified pictorial illustration of an exemplary set of operations to calculate an average monthly expense, constructed and operative in accordance with a preferred embodiment of the present invention;

FIG. 3B is a simplified pictorial illustration of an exemplary set of tables used to calculate an average monthly expense, constructed and operative in accordance with a preferred embodiment of the present invention;

FIG. 4A is a simplified pictorial illustration of an insertion to an exemplary input table and corresponding modifications in exemplary temporary tables, constructed and operative in accordance with a preferred embodiment of the present invention;

FIG. 4B is a simplified pictorial illustration of a modification to an exemplary output table in response to an insertion in an exemplary input table, constructed and operative in accordance with a preferred embodiment of the present invention;

FIG. 5A is a simplified pictorial illustration of a modification to an exemplary input table and corresponding modifications in exemplary temporary tables, constructed and operative in accordance with a preferred embodiment of the present invention;

FIG. 5B is a simplified pictorial illustration of an insertion and modification to an exemplary output table in response to a modification of an exemplary input table, constructed and operative in accordance with a preferred embodiment of the present invention;

FIG. 6A is a simplified pictorial illustration of a further modification to an exemplary input table and corresponding modifications in exemplary temporary tables, constructed and operative in accordance with a preferred embodiment of the present invention; and

FIG. 6B is a simplified pictorial illustration of a deletion and modification to an exemplary output table in response to a modification of an exemplary input table, constructed and operative in accordance with a preferred embodiment of the present invention.

### DETAILED DESCRIPTION OF PREFERRED EMBODIMENTS

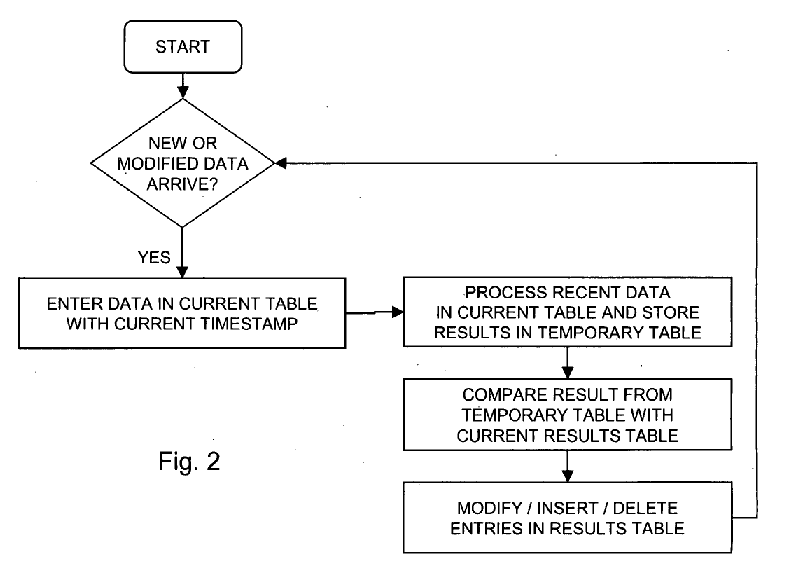

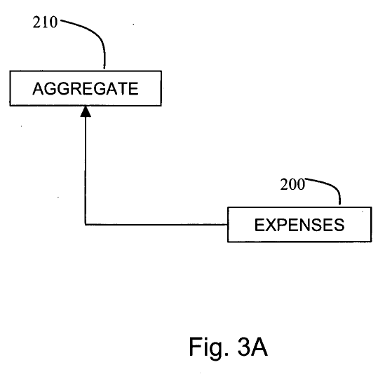

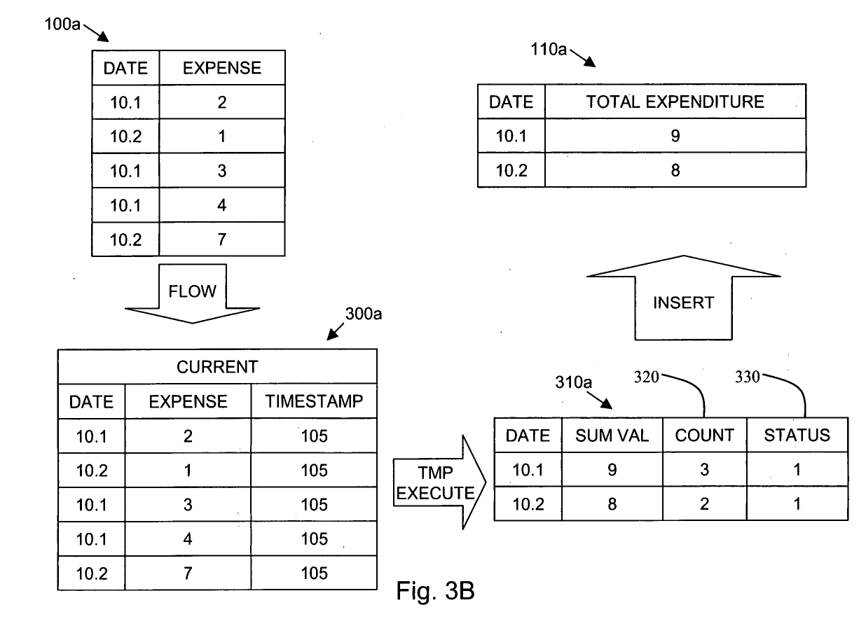

Reference is now made to FIG. 2, which is a simplified flowchart illustration of a method for performing aggregate operations on streaming data, operative in accordance with a preferred embodiment of the present invention. In the method of FIG. 2, data is received, stamped with a timestamp and entered into a first table in a database. Entry of the data may require the insertion of a new record into the database or the modification or the deletion of an old record currently found in the database. A process may then extract the most recent data entered in the database, such as by comparing the most recent timestamp to the timestamp of the last retrieval of data from the database. The process may then execute an aggregate operation on the data, such as a sum, count, avg, max, min, var, stdder, or percentile operation, and store the result of the operation in a temporary table. The data in the temporary table are then analyzed to determine if the most recently received data affects any previously processed data, such as may be stored in an output table. Should the data in the temporary table affect previously processed data in the output table, the process preferably updates the previously stored data in the output table by either modifying, inserting or deleting the stored data, as described in greater detail hereinbelow with reference to FIGS. 3A through 6B.

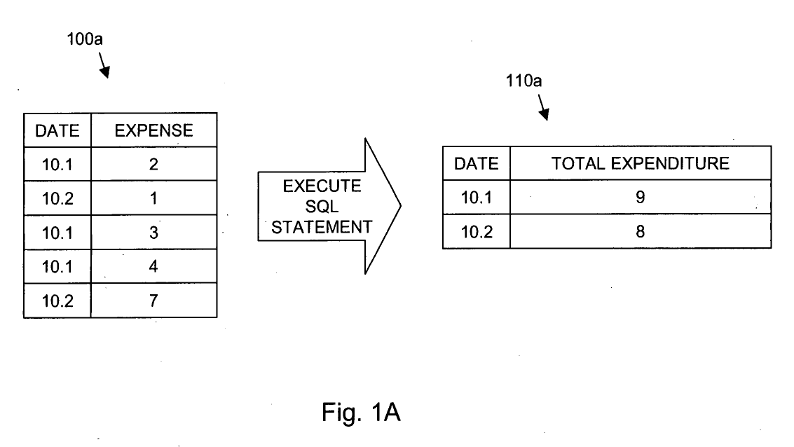

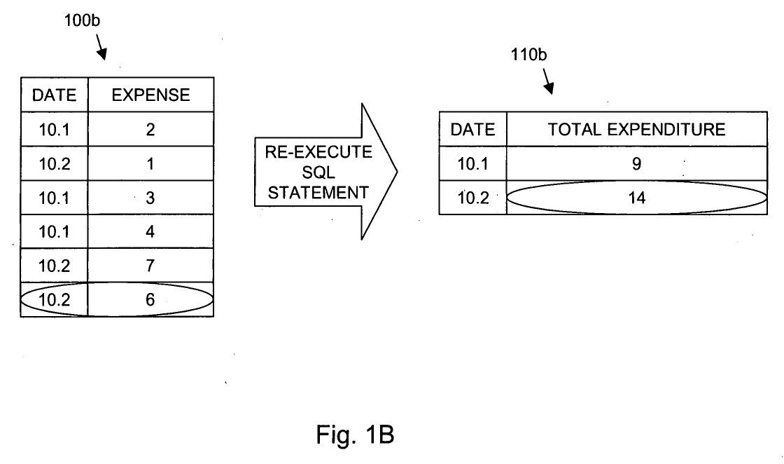

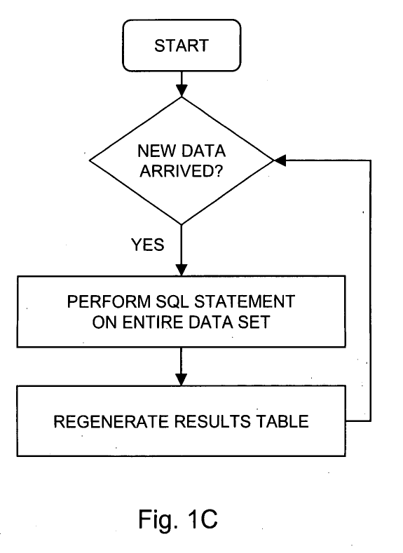

Reference is now made to FIG. 3A, which is a simplified pictorial illustration of an exemplary set of operations for calculating an average monthly expense, constructed and operative in accordance with a preferred embodiment of the present invention, and to FIG. 3B, which is a simplified pictorial illustration of an exemplary set of tables used to calculate an average monthly expense, constructed and operative in accordance with a preferred embodiment of the present invention. In the example described above with reference to FIG. 1A, the aggregate operation is performed directly on the data available in expenditure table 100. In the method of FIG. 2, two processes are discernable, a first process that works directly on the original data and places its results in a temporary table, and a second process that executes the aggregate operation and works with the temporary table created by the first process. These two processes are shown schematically in FIG. 3A, as expenses process 200, responsible for processing the original data found in table 100, and aggregate process 210, responsible for execution of the aggregate operation.

In the example shown in FIG. 3B, at a first time step, expenses process 200 preferably retrieves the data from table 100a, appends the current timestamp, 105, to each row, such as by using techniques described in Applicant/Assignee's co-pending U.S. patent application filed Jun. 16, 2005, and entitled “A system for acquisition, representation and storage of streaming data”, the disclosure of which is incorporated herein by reference, and inserts the resultant rows in a current table 300a. The columns of table 300 typically include the original columns found in table 100 with the addition of a column that retains the timestamp that indicates when expenses process 200 retrieved the data from table 100.

Aggregate process 210 preferably retrieves the most recent data found in table 300a, such as by using techniques described in Applicant/Assignee's co-pending U.S. patent application filed Jun. 16, 2005, and entitled “A system for acquisition, representation and storage of streaming data”, the disclosure of which is incorporated herein by reference, and executes the aggregate operation on the retrieved data placing the results in a temporary table 310a. Table 310 preferably includes additional columns for computation purposes, as is described hereinbelow. Thus, while table 110 stores the final result of the aggregate operation, which may take into account all the received data, table 310 stores an intermediary result of the aggregate operation constructed from the most recent data.

In addition, table 310 stores additional information, such as information that will enable the reconstruction of the final result from intermediary results and further enable the comparison of the final result with the data found in table 110. In the example shown in FIG. 3B, table 310a, includes two columns, labeled count 320 and status 330. Count 320 is utilized to store the number of rows in table 300 that were included in the calculation, and status 330 indicates what action should be performed on the corresponding row in table 110.

In the example shown in FIG. 3B, aggregate process 210 calculates the total expenditure for a particular time by aggregating the rows where the date field corresponds to the particular time in table 300, and placing the sum of the expenses of those rows in table 310. As can been seen in table 310a, two rows have been created to correspond to two dates, 10.1 and 10.2. The sum of the expenses for each date, 9 and 8 respectively, are stored in the column labeled ‘sum val’, and the corresponding count of the number of rows in table 300 for each date is stored in count 320, being 3 and 2 respectively. Status 330 for these two rows is preferably set to a value that indicates that these rows are to be inserted into table 110, such as with the value ‘1’. Aggregate process 210 preferably reviews table 310 and performs the actions associated with each status 330, such as shown in FIG. 3B, inserting all rows where status 330 equal 1 into table 110a.

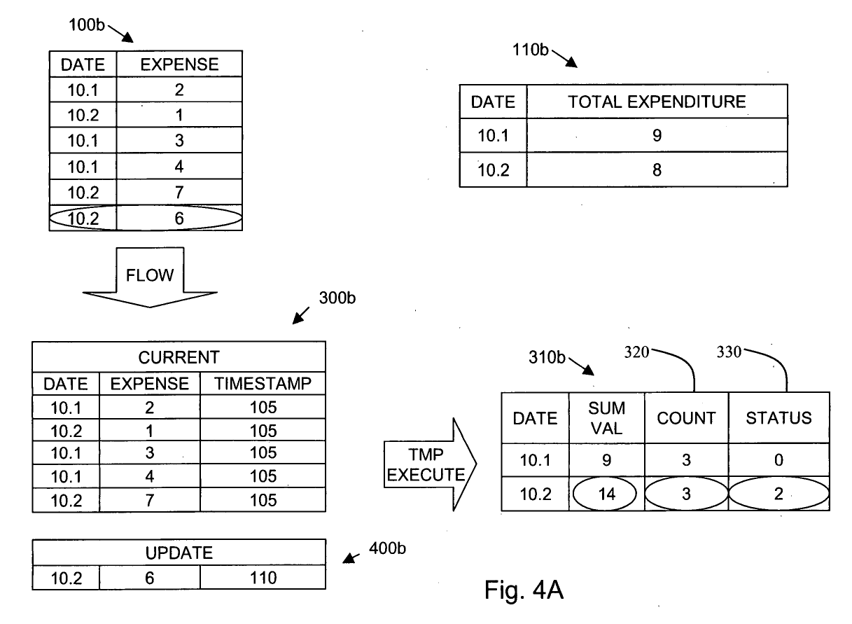

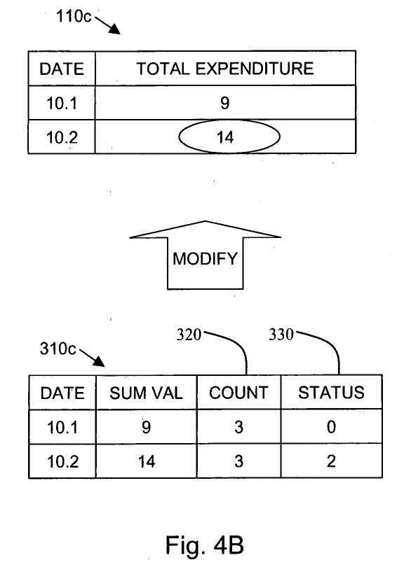

Reference is now made to FIG. 4A, which is a simplified pictorial illustration of an insertion to an exemplary input table and corresponding modifications in exemplary temporary tables, constructed and operative in accordance with a preferred embodiment of the present invention and to FIG. 4B, which is a simplified pictorial illustration of a modification to an exemplary output table in response to an insertion in an exemplary input table, constructed and operative in accordance with a preferred embodiment of the present invention. In the method described hereinabove with reference to FIG. 2, the arrival of new data in the input tables may cause a change to the output tables, such as a modification, insertion or deletion. As described hereinabove with reference to FIGS. 3A and 3B, a process preferably propagates the change from the input table to the output table with the aid of temporary tables. The propagation of an example modification to the temporary tables, as a result of an insertion into the input table, is shown in FIG. 4A.

In the example shown in FIG. 4A, which continues the example discussed hereinabove with reference to FIGS. 3A and 3B, at a second time step a new row is inserted into table 100b with the values of 10.2 and 7 in its columns, corresponding to the date of the expense and the value of the expense respectively. Expenses process 200 preferably retrieves the data from table 100b, appends the current timestamp, 110, and inserts the resultant rows in an update table 400b. Table 400 is functionally similar to table 300, described above with reference to FIG. 3B, with the notable difference that table 400 stores the information not yet processed by aggregate process 210. One methodology by which table 400 may be maintained, such that table 400 only stores information that has not been processed by aggregate process 210, is described in greater detail in Applicant/Assignee's co-pending U.S. patent application filed Jun. 16, 2005, and entitled “A system for acquisition, representation and storage of streaming data”, the disclosure of which is incorporated herein by reference.

Aggregate process 210 preferably retrieves the data found in table 400b, and executes the aggregate operation on the retrieved data. In the example shown in FIG. 4A, the results of the aggregate operation modify the second row of table 310, changing the sum value from 8 to 14 and the row's count 320 from 2 to 3. Aggregate process 210 preferably marks the changed row by placing an indication of modification, such as the value ‘2’, in the row's status 330. Aggregate process 210 preferably reviews table 310c, and performs the actions associated with each status value, as shown in FIG. 4B, modifying the second row of table 110c, changing the value of the total expenditure for the second row to 14 from 8.

As can be seen in the example shown in FIGS. 3B, 4A and 4B, table 110 has not been reconstructed, but rather only the modifications performed on table 100 have been propagated through tables 400 and 310 to table 110, thus focusing the computation work only on the changes.

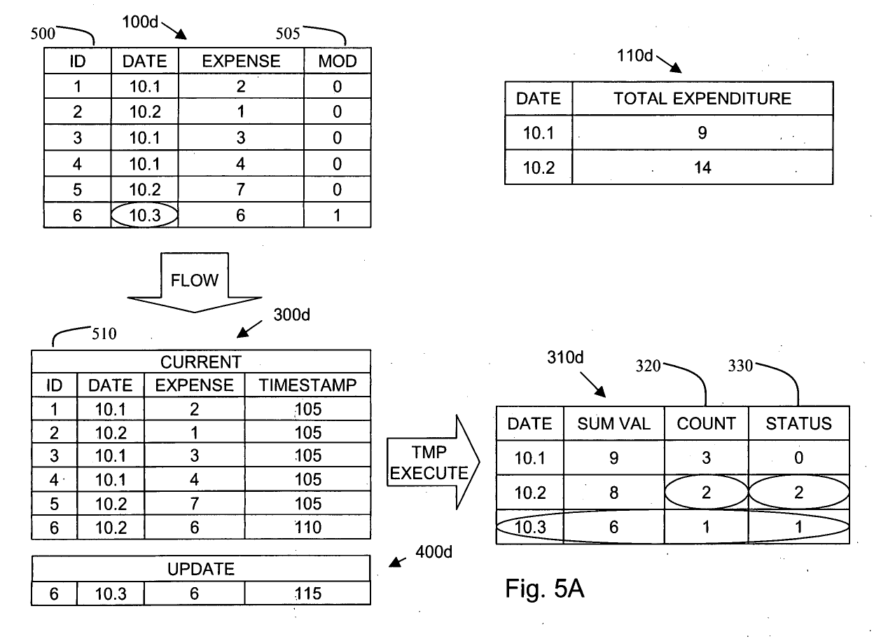

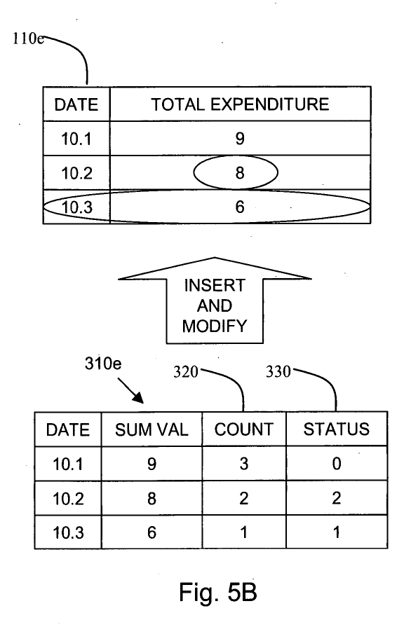

Reference is now made to FIG. 5A, which is a simplified pictorial illustration of a modification to an exemplary input table and corresponding modifications in exemplary temporary tables, constructed and operative in accordance with a preferred embodiment of the present invention, and to FIG. 5B, which is a simplified pictorial illustration of an insertion and modification to an exemplary output table in response to a modification of an exemplary input table, constructed and operative in accordance with a preferred embodiment of the present invention. In the method described hereinabove with reference to FIG. 2, a single modification to the data in the input table may cause multiple changes to the output table, such as a modification and an insertion. As described hereinabove with reference to FIGS. 3A and 3B, a process preferably propagates the change from the input table to the output table with the aid of temporary tables. An example of the propagation of a modification to the temporary tables, as a result of a modification to the input table, is shown in FIG. 5A.

Modifications to old data, as described above with reference to FIG. 2, are ascertained by correlating the rows of data in table 100 with the data in table 300. In the example shown in FIG. 5A, each new row of data is preferably given a unique identifier 500, shown in the first column of table 100d. When the data is copied into table 300 the identifier is preserved, thus enabling each row in table 100 to be correlated with the data in table 300.

At a fourth time step, the last row in table 100, identified by the number 6, is modified, as is shown in 100d. The modification involves changing the date field from 10.2 to 10.3. The modified row is preferably marked, such as by setting a flag in a column 505, labeled ‘mod’. Expenses process 200 preferably identifies rows that are modified and retrieves the modified data from table 100d, appends the current timestamp, 115, and inserts the resultant rows in update table 400d, preserving the identifier in a column 510, labeled ‘id’. Aggregate process 210 may then re-interpret previous instances of rows identified by the same identifier 510, such as by employing techniques described in greater detail in Applicant/Assignee's co-pending U.S. patent application filed Jun. 16, 2005, and entitled “A system for acquisition, representation and storage of streaming data”, the disclosure of which is incorporated herein by reference.

Aggregate process 210 preferably retrieves the most recent data found in table 400 and searches table 300 for rows that have the same identifier 510. Aggregate process 210 then analyzes the rows found in light of the aggregate operation previously performed on the retrieved data. Aggregate process 210 may then determine that a recent row from update 400 supercedes a row from current 300. Aggregate process 210 may then remove the effects that the superceded row had on table 310, after execution of the aggregation operation, and replace it with the results of the aggregation operation on the superceding row found in update 400.

In the example shown in FIG. 5A, the new row found in update 400d, has an identifier 510 value of 6 and as such supercedes the last row of table 300d, whose identifier 510 value is also 6. Aggregate process 210 then removes the effects of the superceded row by modifying the second row of table 310, changing the sum value from 14 to 8 and the count from 3 to 2. Additionally, aggregate operator 210 further causes an additional row, a third row, to be inserted in table 310d, to reflect the effects of the aggregation operation on the superceding row.

Aggregate process 210 preferably marks the changed row, the second row, by placing an indication of a modification, such as the value ‘2’, in the status column and preferably marks the new row, the third row, by placing an indication of an insertion, such as the value ‘1’, in the status column.

Aggregate process 210 preferably reviews table 310 and performs the actions associated with each status value, as shown in FIG. 5B, modifying the second row of table 110e, and inserting a new row, a third row in the table.

As can be seen in the example shown in FIGS. 5A and 5B, table 110 has not been reconstructed, but rather only the single modification done to table 100 has been propagated through tables 300, 400 and 310 to table 110, thus focusing the computation work only on the changes.

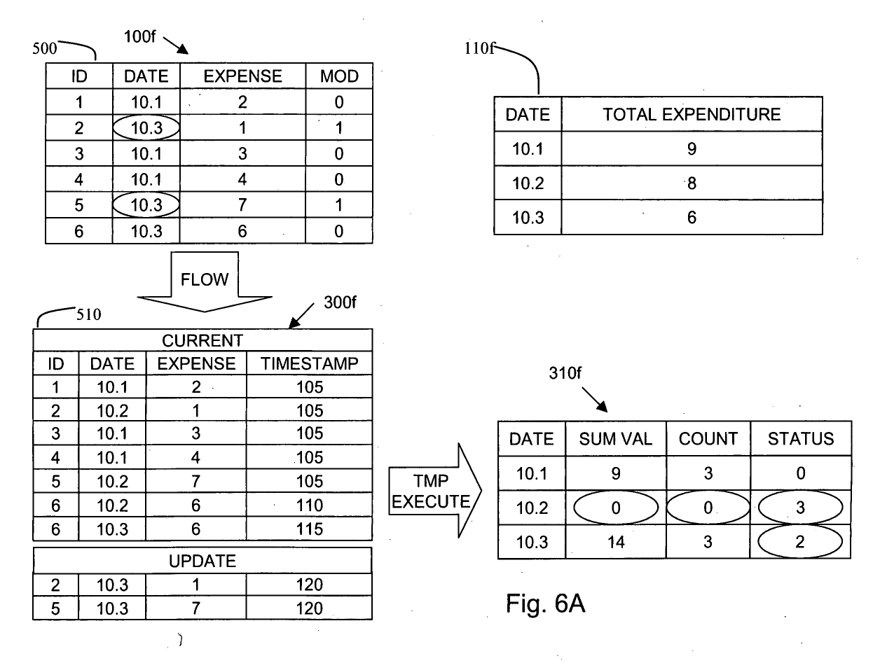

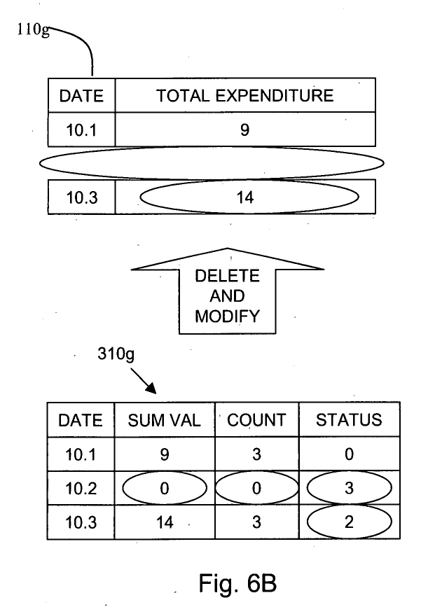

Reference is now made to FIG. 6A, which is a simplified pictorial illustration of a further modification to an exemplary input table and corresponding modifications in exemplary temporary tables, constructed and operative in accordance with a preferred embodiment of the present invention, and to FIG. 6B, which is a simplified pictorial illustration of a deletion and modification to an exemplary output table in response to a modification of an exemplary input table, constructed and operative in accordance with a preferred embodiment of the present invention. In the method described hereinabove with reference to FIG. 2, a single modification to the data in the input table may cause a deletion of a row in the output table as well as modifications in the output table. As described hereinabove with reference to FIGS. 3A and 3B, a process preferably propagates the change from the input table to the output table with the aid of temporary tables. An example of the propagation of a modification to the temporary tables, as a result of a modification to the input table, is shown in FIG. 6A.

In the example shown in FIG. 6A, which continues the example discussed hereinabove with reference to FIGS. 5A and 5B, at a sixth time step the second and fifth rows in table 100f, are modified, changing the date fields from 10.2 to 10.3. The modified rows are preferably marked, such as by setting a flag in a column 505, labeled ‘mod’. Expenses process 200 preferably retrieves the data from table 100f, appends the current timestamp, 120, and inserts the resultant rows in a table 400f, preserving the identifier in a column 510, labeled ‘id’.

As described above with reference to FIG. 5A, aggregate process 210 may re-interpret previous instances of rows in table 300 identified by the same identifier 510 as those found in table 400.

In the example shown in FIG. 6A, the two new rows found in update 400f, have the identifier 510 values of ‘2’ and ‘5’ and as such supercede the corresponding rows of table 300f, whose identifier 510 values are also ‘2’ and ‘5’. Aggregate process 210 then removes the effects of the superceded rows by modifying the second row of table 310, changing the sum value from 8 to 0 and the count from 2 to 0. Additionally, aggregate operator 210 further modifies the third row in table 310d, to reflect the effects of the aggregation operation on the superceding rows.

Since the second row in table 310 contains a count of 0, aggregate process 210 preferably marks the second row by placing an indication of deletion, such as the value ‘3’, in the status column and preferably marks the third row by placing an indication of a modification, such as the value ‘2’, in the status column.

Aggregate process 210 preferably reviews table 310 and performs the actions associated with each status value, as shown in FIG. 6B, deleting the second row of table 110g and modifying the third row in the table.

As can be seen in the example shown in FIGS. 6A and 6B, table 110 has not been reconstructed, but rather only the single modification done to table 100 has been propagated through tables 300, 400 and 310 to table 110, thus focusing the computation work only on the changes.

It is appreciated that one or more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A method for performing aggregate operations on streaming data, the method comprising:
executing an aggregation operation on data items in a set of data;
maintaining the results of said aggregation operation in a temporary table together with metadata relating to said aggregation operation;
maintaining the results of said aggregation operation in an output table;
receiving a new data item not in said set of data;
analyzing said metadata to determine if executing said aggregation operation on said data items in said set of data and said new data item would affect said results; and
updating said output table as a function of said new data item.

2. A method according to claim 1 and further comprising:
associating a timestamp with each of said data items; and
identifying said new data item as having a timestamp that is later than the oldest timestamp of any of said data items reflected in said results.

3. A method according to claim 1 wherein said updating step comprises inserting a new record into said output table to accommodate the results of said function.

4. A method according to claim 1 wherein said updating step comprises modifying an existing record in said output table to accommodate the results of said function.

5. A method according to claim 1 wherein said updating step comprises deleting an existing record in said output table to accommodate the results of said function.

6. A method according to claim 1 wherein said first maintaining step comprises maintaining the number of rows of said data items reflected in said results.

7. A method according to claim 1 wherein said first maintaining step comprises maintaining an indicator of an action that should be performed on said output table responsive to said new data item.

8. A method according to claim 7 and further comprising indicating via said indicator any of insertion, deletion, modification, and no-action actions.

9. A method for performing aggregate operations on streaming data, the method comprising:
executing an aggregation operation on data items in a set of data;
maintaining the results of said aggregation operation in a temporary table together with metadata relating to said aggregation operation;
maintaining the results of said aggregation operation in an output table;
determining that one of said data items in said set of data has been modified;
analyzing said metadata to determine if executing said aggregation operation on said data items in said set of data including said modified data item would affect said results; and
updating said output table as a function of said modified data item.

10. A method according to claim 9 and further comprising modifying said temporary table as a function of said modified data item.

11. A method according to claim 9 and further comprising:
associating a unique identifier with each of said data items;
maintaining a copy of said data items in said set of data in a current table together with their unique identifiers;
identifying said modified data item as having a modification indicator;
maintaining a copy of said modified data item in an update table together with its unique identifier;
updating said temporary table as a function of said data item in said current table having the same unique identifier as said data item in said update table; and
updating said temporary table as a function of said modified data item in said update table.

12. A system for performing aggregate operations on streaming data, the system comprising:
means for executing an aggregation operation on data items in a set of data;
means for maintaining the results of said aggregation operation in a temporary table together with metadata relating to said aggregation operation;
means for maintaining the results of said aggregation operation in an output table;
means for receiving a new data item not in said set of data;
means for analyzing said metadata to determine if executing said aggregation operation on said data items in said set of data and said new data item would affect said results; and
means for updating said output table as a function of said new data item.

13. A system according to claim 12 and further comprising:
means for associating a timestamp with each of said data items; and
means for identifying said new data item as having a timestamp that is later than the oldest timestamp of any of said data items reflected in said results.

14. A system according to claim 12 wherein said means for updating comprises inserting a new record into said output table to accommodate the results of said function.

15. A system according to claim 12 wherein said means for updating comprises modifying an existing record in said output table to accommodate the results of said function.

16. A system according to claim 12 wherein said means for updating comprises deleting an existing record in said output table to accommodate the results of said function.

17. A system according to claim 12 wherein said first means for maintaining comprises maintaining the number of rows of said data items reflected in said results.

18. A system according to claim 12 wherein said first means for maintaining comprises maintaining an indicator of an action that should be performed on said output table responsive to said new data item.

19. A system according to claim 18 and further comprising means for indicating via said indicator any of insertion, deletion, modification, and no-action actions.

20. A system for performing aggregate operations on streaming data, the system comprising:
means for executing an aggregation operation on data items in a set of data;
means for maintaining the results of said aggregation operation in a temporary table together with metadata relating to said aggregation operation;
means for maintaining the results of said aggregation operation in an output table;
means for determining that one of said data items in said set of data has been modified;
means for analyzing said metadata to determine if executing said aggregation operation on said data items in said set of data including said modified data item would affect said results; and
means for updating said output table as a function of said modified data item.

21. A system according to claim 20 and further comprising means for modifying said temporary table as a function of said modified data item.

22. A system according to claim 20 and further comprising:
means for associating a unique identifier with each of said data items;
means for maintaining a copy of said data items in said set of data in a current table together with their unique identifiers;
means for identifying said modified data item as having a modification indicator;
means for maintaining a copy of said modified data item in an update table together with its unique identifier;
means for updating said temporary table as a function of said data item in said current table having the same unique identifier as said data item in said update table; and
means for updating said temporary table as a function of said modified data item in said update table.
